(19) United States
(12) Patent Application Publication
(10) Pub. No.: US 2010/0052207 A1
(43) Pub. Date: Mar. 4, 2010

(54) Method of Preparing Microarray by Using Optically Transparent Array Mold with Concave Portion

(76) Inventors: Taeseok Sim, Seoul (KR); Dongho Lee, Seongham-si (KR)

Correspondence Address: F. CHAU & ASSOCIATES, LLC, 130 WOODBURY ROAD, WOODBURY, NY, 11797, US

(21) Appl. No.: 12/391,907

(22) Filed: Feb. 24, 2009

(30) Foreign Application Priority Data
Aug. 27, 2008 (KR) 10-2008-0084044

(51) Int. Cl. B29C 33/40

(52) U.S. Cl. 264/219

(57) ABSTRACT

A method of preparing a microarray includes preparing an array mold having a concave portion comprising a fluidic channel having a fluid inlet and a fluid outlet, wherein the array mold comprises an optically transparent material; adhering a substrate to a surface of the array mold in which the concave portion is formed to form an adhered structure comprising the array mold and the substrate, the adhered structure comprising a chamber defined by a space between the concave portion and the substrate; and introducing a biomaterial into the chamber via the fluid inlet of the adhered structure to immobilize the biomaterial on a surface of the substrate in the chamber.

### CROSS-REFERENCE TO RELATED APPLICATIONS

This application claims priority from Korean Patent Application No. 10-2008-0084044, filed on Aug. 27, 2008, in the Korean Intellectual Property Office, the contents of which are herein incorporated by reference in their entirety.

### BACKGROUND

1. Field

The present disclosure is directed to a method of preparing a microarray using an array mold comprising a concave portion including a fluidic channel having a fluid inlet and a fluid outlet.

2. Description of the Related Art

Methods of preparing microarrays are well known and widely used. Two such methods include using photolithography and a spotting method. The former is a method of gradually synthesizing a probe material on a surface of a substrate to immobilize the probe material thereon, and the latter is a method of immobilizing a previously synthesized probe material on an activated surface of a substrate.

FIG. 1 is a flowchart illustrating a general method of using photolithography. This method involves gradually synthesizing a probe material on a surface of a substrate to immobilize the probe material thereon. Referring to FIG. 1, a nucleic acid with a photoremovable protecting group bound thereto (a) is deposited on a substrate (b), the substrate is exposed to light via a photomask (c) to remove the protecting group (d), and the exposed portion from which the protecting group was removed is coupled with a nucleic acid (e). These processes are repeatedly performed to prepare a microarray on which a nucleic acid probe is immobilized.

With regards to the method of immobilizing the previously synthesized probe on the surface of the substrate, a known method of manufacturing a DNA chip includes providing a substrate on which a solidifying agent is coated on a front surface of a slide glass, mounting one by one on the surface of the substrate by spotting a droplet that includes a previously prepared probe DNA, and drying the droplet.

However, in the first method of gradually synthesizing the probe material on the surface of the substrate to immobilize the probe material thereon, a large amount of the photomask, which is expensive, is used, and the used photomask cannot be reused. In addition, the process of immobilizing a biomaterial on a surface of a substrate is generally performed in a liquid phase of the biomaterial. Thus, if a stepper is used in the process, a large amount of the biomaterial is needed, and it is challenging to perform the process in a liquid phase. Therefore, microarray manufacturing costs are high, processes of manufacturing microarrays are complicated, and the yield is low. In addition, in the second method of immobilizing the previously synthesized probe on the surface of the substrate, reaction efficiency is low, and activation may not be uniformly conducted.

### SUMMARY OF THE INVENTION

Exemplary embodiments of the invention include a method of efficiently preparing a microarray using an array mold including a concave portion.

Exemplary embodiments of the invention may include a method of preparing a microarray, the method comprising: preparing an array mold with a concave portion arranged thereon, the concave portion comprising a fluidic channel having a fluid inlet and a fluid outlet, wherein the array mold comprises an optically transparent material; adhering a substrate to a surface on which the concave portion of the array mold is arranged to form an adhered body of the array mold and the substrate, the adhered body comprising a chamber defined by a space between the concave portion and the substrate; and introducing a biomaterial into the chamber via the fluid inlet of the adhered body to immobilize the biomaterial on a surface of the substrate in the chamber.

### BRIEF DESCRIPTION OF THE DRAWINGS

FIG. 1 is a flowchart illustrating a general method of using photolithography to prepare a microarray (DNA chip).

FIG. 2 is a diagram for explaining a method of preparing an array mold, according to an embodiment of the invention.

FIG. 3A is an orthographic projection view of top and side surfaces of an array mold, according to an embodiment of the invention.

FIG. 3B is an orthographic projection view of bottom and side surfaces of an array mold, according to an embodiment of the invention

FIG. 4 is a diagram for explaining a process of injecting a biomaterial through a fluid inlet, filling a chamber with the biomaterial, and exhausting the remaining biomaterial through a fluid outlet, in a state in which an array mold and substrate are adhered to each other, according to an embodiment of the invention.

FIGS. 5A and 5B are diagrams illustrating a state where a biomaterial is deposited on a surface of a substrate according to a pattern of a concave portion in an array mold to be immobilized as a probe, according to an embodiment of the invention.

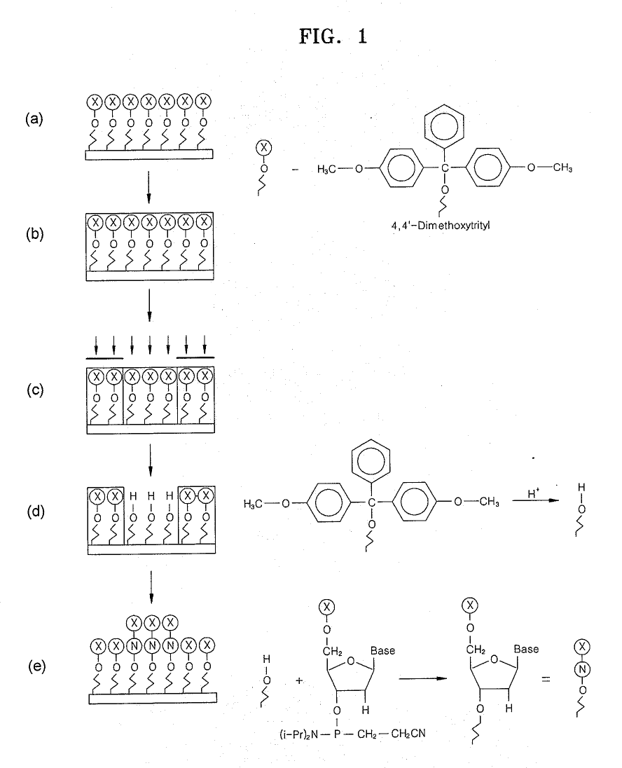

### DETAILED DESCRIPTION OF EXEMPLARY EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

A method according to an embodiment of the invention of preparing a microarray includes preparing an array mold comprising a concave portion including a fluidic channel having a fluid inlet and a fluid outlet, wherein the array mold comprises an optically transparent material.

The fluid inlet includes an inlet through which a material needed for immobilization of a probe of a microarray or a probe is introduced to fill the concave portion of the array mold.

The fluid outlet includes an outlet through which a left over material is exhausted.

The fluidic channel includes the fluid inlet and the fluid outlet, and is connected to the concave portion of the array mold. [0019] The concave portion is a portion that is adhered onto a surface of a substrate and faces the substrate and that includes the fluidic channel including the fluid inlet and fluid outlet in the array mold. There may be a plurality of concave portions in a variety of sizes according to a spot pattern of a microarray.

The array mold comprises an optically transparent material. The array mold may comprise any material that facilitates the preparation of an internal structure such as the concave portion including a fluidic channel having a fluid inlet and a fluid outlet, is optically transparent, and has a strong adhesion with respect to a surface of a microarray substrate. The “optically transparent material” may be indium tin oxide (ITO), glass, optically transparent plastic, or optically transparent silicon. The array mold may comprise polydimethylsiloxane (PDMS).

The array mold may be prepared using, for example, a photolithographic process using a negative photoresist, which is well known to one of ordinary skill in the art.

A method according to an embodiment of the invention of preparing a microarray includes adhering a substrate to a surface of a portion in which the concave portion of the array mold is arranged to form an integrated adhered structure including a chamber defined by a space between the concave portion and the substrate.

The chamber includes an inner space of the adhered structure, which is isolated from the outside by the adhesion between the array mold and the substrate and in which the immobilization of the probe of the microarray is performed. The adhesion occurs between a portion along side the concave portion of the array mold and a portion along side a spot region immobilized on the surface of the substrate. The adhesion provides the chamber into which the biomaterial introduced through the fluid inlet is immobilized on the surface of the substrate, and prevents contamination between the biomaterials by preventing the biomaterial introduced into the chamber from leaking out to another concave portion. The adhesion may be performed using an adhesive material, or using adhesive properties of the substrate and array mold themselves. The adhered structure includes a structural body obtained by the adhesion between the array mold and the substrate.

A method according to an embodiment of the invention of preparing a microarray includes introducing a biomaterial into the chamber via the fluid inlet of the adhered structure to immobilize the biomaterial on a surface of the substrate in the chamber.

The biomaterial includes a probe or any material comprising a probe in the manufacturing of the microarray. For example, the biomaterial may be one selected from the group comprising DNA, RNA, LNA, PNA, peptide, a virus, and a cell, or a monomer, such as nucleotide, nucleoside, or amino acid. The biomaterial may be derived from a living organism, or synthesized or semi-synthesized.

Immobilization may include depositing previously synthesized probe molecules on a surface of an activated substrate. The immobilization of the biomaterial on the surface of the microarray substrate is well known to those of ordinary skill in the art. A method according to an embodiment of the invention of activating a predefined region of a substrate, and then contacting the predefined region of the substrate with a previously selected monomer solution is provided. The predefined region belongs to the portion of the surface of the substrate of the chamber of the adhered structure, and may be activated by a light source. The remaining portion of the substrate is blocked from the light source, thus remains inert. According to an embodiment of the invention, the predefined region, is either exposed to light to be active, or exposed to a reactive material. The remaining portion of the substrate is a portion adhered to the array mold, and is physically blocked from contact with a reactant. In addition, the surface of the substrate may be treated with a material having a functional group that can bind the biomaterial. The functional group may be, but is not limited to, an amine group, a carboxyl group, an epoxy group, or a sulfur group. The material having the functional group that can bind the biomaterial may be, but is not limited to, γ-aminopropyltriethoxysilane (GAPS). As described above, in the process of immobilizing the biomaterial on the surface of the substrate, adsorption, a chemical reaction, or physical interaction between the substrate and probe may occur. Such reaction may support, accelerate or catalyze the production of the microarray.

The immobilizing of the biomaterial on the surface of the substrate includes: exposing the substrate to light via a top portion of the chamber of the adhered structure to expose an active group screened by a photoremovable protecting group on the surface of the substrate; and contacting the exposed active group with an activated monomer protected by the photoremovable protecting group to couple the active group on the surface of the substrate with the monomer.

Exposing to light includes irradiation of gamma-rays, X-rays, infrared rays, visible rays or ultraviolet rays to the surface of the substrate of the microarray and any irradiation needed in a process according to an embodiment of the invention of preparing the microarray, such as measurement of stabilization and optical analysis of patterned probe, or a UV cross link. The type of light may be appropriately selected according to the type of the photoremovable protecting group.

The top portion of the chamber is a part of the array mold comprising the optically transparent material, and thus the light exposure can be performed where the chamber is filled with the biomaterial without separating the adhered structure into the array mold and the substrate. When a general photolithographic method is used, the light exposure should be performed on the surface of the substrate through a patterned photomask to patternize a spot on the surface of the substrate. However, in preparing the microarray according to an embodiment of the invention, a pattern is formed on the surface of the substrate by the array mold including the concave portion, and thus a separate photomask is not required.

The protecting group is a group, such as an activator, that is chemically bound to a monomer unit and can be removed by a selective exposure to an electromagnetic wave. The photoremovable protecting group is a protecting group that can be removed by light. Photoremovable protecting groups are well known to those of ordinary skill in the art. Examples of the photoremovable protecting group may include, but are not limited to, 6-nitroveratryloxycarbonyl (NVOC), 6-nitropiperonyl (NP), 6-nitropiperonyl oxycarbonyl (NPOC), 6-nitroveratryl (NV), methyl-6-nitroveratryl (MeNV), methyl-6-nitroveratryloxycarbonyl (MeNVOC), methyl-6-nitropiperonyl (MeNP), and methyl-6-nitropiperonyloxycarbonyl (MeNPOC).

The monomer may be one selected from the group comprising a nucleotide, a nucleoside, and an amino acid. Thus, the nucleotide, the nucleoside, or the amino acid that fills the chamber through the fluid inlet may be prepared as a monomer that comprises the probe of the microarray.

The array mold may include at least two concave portions, each of which includes a fluidic channel having a fluid inlet and a fluid outlet. The concave portions may be configured where a fluid outlet of a first concave portion is connected to a fluid inlet of a second concave portion to form a fluidic channel. Thus, an array mold including a plurality of concave portions can be prepared, thereby preparing a microarray with a variety of probe patterns.

The concave portions may be connected to a single fluid inlet. Thus, the array mold may include at least one fluid inlet according to a probe pattern of a microarray. That is, when the same materials fill the chambers, an array mold with concave portions including a single fluid inlet is configured, and when the materials that fill the chambers are different from each other, an array mold with concave portions including at least two fluid inlets is configured.

The array mold may comprise any material that facilitates the preparation of an internal structure such as the concave portion including a fluidic channel having a fluid inlet and a fluid outlet, is optically transparent, and can strongly adhere to a surface of a microarray substrate. For example, the array mold may comprise PDMS.

The substrate may be one selected from the group comprising silicon, glass, metal, plastic, and ceramic. In particular, the substrate may be one selected from the group comprising silicon, glass, gold, silver, copper, platinum, polystyrene, polymethylacrylate, polycarbonate, and ceramic.

The substrate may be treated with SiO₂ as an oxide film-forming material before adhering the substrate and the array mold, when the array mold comprises, for example, silicon. The treatment of the substrate with SiO₂ can increase an adhesion between the substrate and the array mold or the biomaterial that fills the chamber through the fluid inlet. The treatment of the substrate with SiO₂ may be performed before or after adhering the array mold and the substrate.

The substrate may be treated with a material that can bind the biomaterial on the surface of the substrate. A material for binding the biomaterial may be any material that can treat the surface of the substrate of the microarray to immobilize a probe thereon. For example, the material may be, but is not limited to, a linker, GAP, an amine group, a carboxyl group, an epoxy group, a sulfur group, an aldehyde group, activated ester, maleimide, or a carbohydrate. The treatment of the substrate with the material may be performed before or after adhering the array mold and the substrate.

A material for binding the biomaterial on the surface of the substrate may be one selected from the group comprising DNA, RNA, LNA, PNA, peptide, a virus, and a cell. Thus, DNA, RNA, LNA, PNA, peptide, a virus or a cell, which fills the chamber through the fluid inlet, may be prepared as the probe of the microarray.

The monomer may be one selected from the group comprising a nucleotide, a nucleoside, and an amino acid.

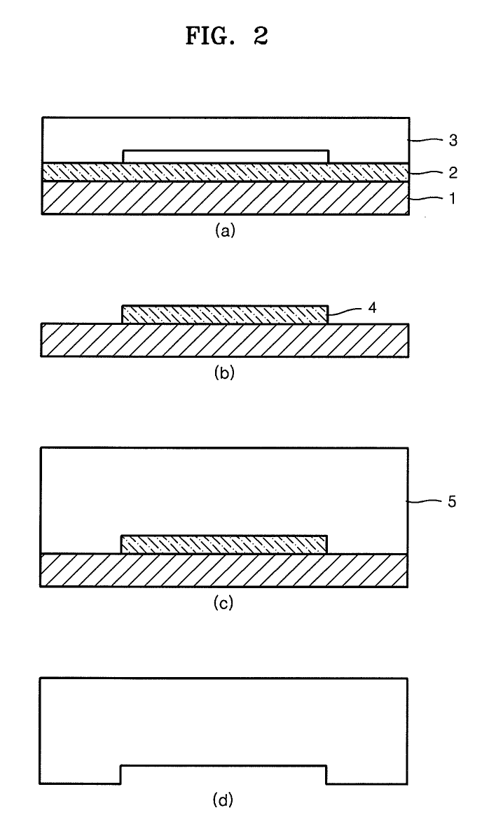

FIG. 2 is a diagram for explaining a method of preparing an array mold, according to an embodiment of the invention.

Referring to FIG. 2, the array mold may be prepared using a well-known method in the art, for example, photolithography. In particular, in operation (a), a photoresist layer 2 having a desired thickness is coated on a substrate 1, and a photomask 3 having a light exposure portion with a desired area is formed on the photoresist layer 2. In operation (b), when an exposure to light is performed through the photomask 3, only a portion of the photoresist layer 2 corresponding to the light exposure portion of the photomask 3 remains, constituting a remainder portion 4, and a portion of the photoresist layer 2 corresponding to a non-light exposure portion is removed (negative photoresist). In operation (c), a mold is formed in the substrate 1 by the remaining portion 4 of the photoresist layer 2 and PDMS 5 is poured onto the mold to be solidified. In operation (d), the substrate 1 and the remaining portion 4 of the photoresist layer 2 are removed to prepare a PDMS array mold having a concave portion with a predefined pattern. The pattern of the concave portion corresponds to a predefined portion in which a probe is to be immobilized on the surface of the substrate of the microarray.

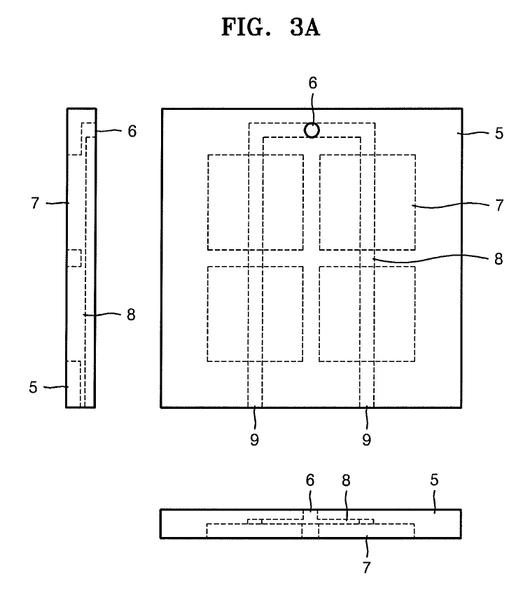

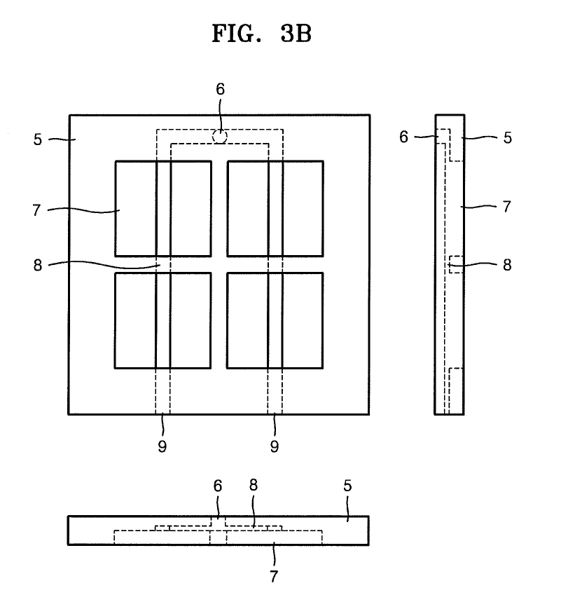

FIGS. 3A and 3B are orthographic projection views of top and side surfaces and bottom and side surfaces of an array mold, respectively, according to an embodiment of the invention.

Referring to FIG. 3A, the array mold includes a fluid inlet 6 into which a biomaterial may be injected and which is connected to concave portions 7 and fluid outlets 9 through a fluidic channel 8 in the array mold. Referring to FIG. 3B, the concave portions 7 corresponding to a substrate of a microarray and the fluidic channel 8 through which the biomaterial flows are exposed in the bottom surface of the array mold.

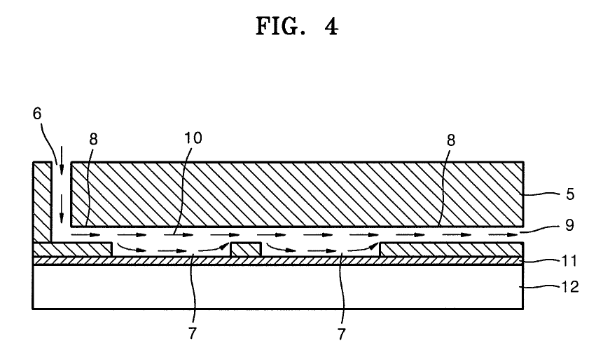

FIG. 4 is a diagram for explaining a process of injecting a biomaterial through a fluid inlet, filling chambers with the biomaterial, and exhausting the remaining biomaterial through a fluid outlet, in a state in which an array mold and substrate are adhered to each other, according to an embodiment of the invention.

A process according to an embodiment of the invention of filling each chamber with the biomaterial by using the array mold is as illustrated in FIG. 4. A biomaterial 10 that is to be immobilized on a surface of a microarray substrate 12 is injected through a fluid inlet 6 that is disposed in a top surface of an array mold 5. The biomaterial 10 flows through a fluidic channel 8 to fill the chambers on the surface of the microarray substrate 12 in concave portions 7 of the array mold 5, and the remaining biomaterial 10 is exhausted from the array mold 5 through a fluid outlet 9. The surface of the microarray substrate 12 is treated with SiO₂ 11, and thus the array mold 5 strongly adheres to the surface thereof and the biomaterial 10 is easily immobilized on the surface thereof. The fluidic channel 8, fluid inlet 6 and fluid outlet 9 that are connected to the concave portions 7 inside the array mold 5 may be easily prepared by one of ordinary skill in the art.

A method according to an embodiment of the invention of preparing a microarray includes exposing the biomaterial that fills the chamber to light in the state in which the array mold and the substrate are adhered to each other. The biomaterial is deposited on the surface of the substrate in an isolated state in the concave portion of the array mold, and the array mold comprises an optically transparent material. Thus, the light exposure may be performed when the array mold and the substrate are adhered to each other.

To prevent contamination between biomaterials that are filled in each chamber of the array mold or the biomaterial from leaking out, the adhesion between the array mold and the microarray substrate should be strong. Thus, the array mold may comprise PDMS, but is not limited thereto. PDMS can strongly adhere to silicon, glass, plastic, or ceramic, each of which may be used as a microarray substrate material. In addition, if the microarray substrate comprises silicon, the microarray substrate may be surface-treated with SiO₂ to form an oxide film layer to strengthen the adhesion between the array mold and the microarray substrate.

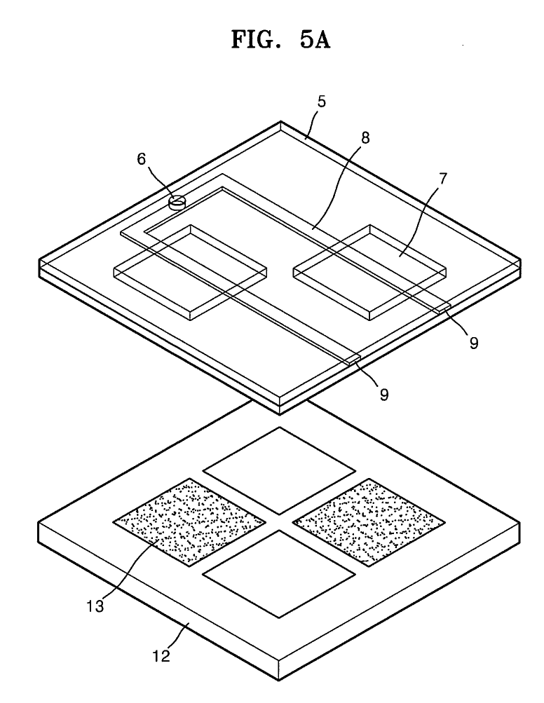

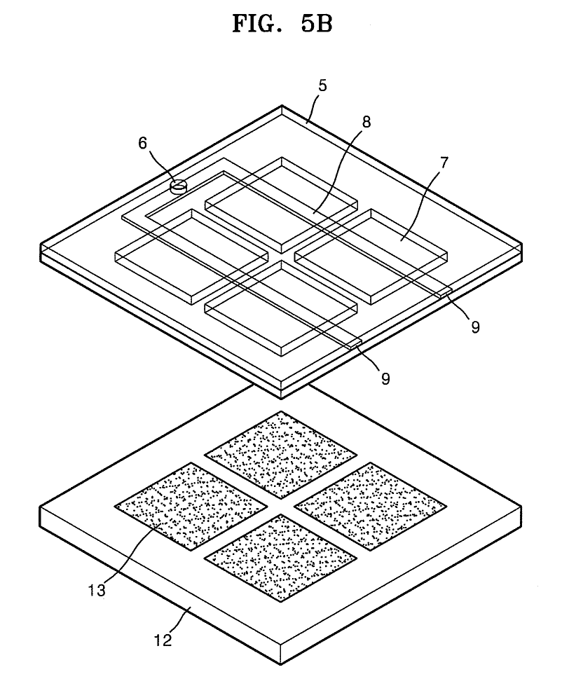

FIGS. 5A and 5B are diagrams illustrating a state in which a biomaterial is deposited on a surface of a substrate according to a pattern of a concave portion in an array mold 5 to be immobilized as a probe, according to an embodiment of the invention. Referring to FIG. 5A, the array mold 5 includes two concave portions 7, and a probe is immobilized only on portions 13 of a microarray substrate 12, the portions 13 corresponding to the two concave portions 7. Referring to FIG. 5B, the array mold 5 includes four concave portions 7, and a probe is deposited and immobilized only on portions 13 of the microarray substrate 12, the portions 13 corresponding to the four concave portions 7. In addition, referring to FIGS. 5A and 5B, the array mold 5 includes a single fluid inlet 6, and the same biomaterial is introduced through the fluid inlet 6.

It should be understood that the exemplary embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form and details may be made therein without departing from the spirit and scope of the present invention as defined by the following claims.

What is claimed is:

1. A method of preparing a microarray, the method comprising:
preparing an array mold comprising a concave portion comprising a fluidic channel having a fluid inlet and a fluid outlet, wherein the array mold comprises an optically transparent material;
adhering a substrate to a surface of the array mold in which the concave portion is formed to form an adhered structure comprising the array mold and the substrate, the adhered structure comprising a chamber defined by a space between the concave portion and the substrate; and
introducing a biomaterial into the chamber via the fluid inlet of the adhered structure to immobilize the biomaterial on a surface of the substrate in the chamber.

2. The method of claim 1, wherein immobilizing the biomaterial comprises: exposing the substrate to light via a top portion of the chamber of the adhered structure to expose an active group on the surface of the substrate screened by a photoremovable protecting group; and contacting the exposed active group with an activated monomer protected with the photoremovable protecting group to couple the active group on the surface of the substrate with the monomer.

3. The method of claim 1, wherein the array mold comprises at least two concave portions substantially identical to each other.

4. The method of claim 3, wherein the at least two concave portions comprise a first concave portion and a second concave portion, are configured wherein a fluid outlet of the first concave portion and a fluid inlet of the second concave portion are connected to each other to form a fluidic channel.

5. The method of claim 3, wherein the at least two concave portions are connected to a single fluid inlet.

6. The method of claim 1, wherein the array mold comprises polydimethylsiloxane (PDMS).

7. The method of claim 1, wherein the substrate is selected from one of silicon, glass, metal, plastic, or ceramic.

8. The method of claim 1, wherein the substrate is treated with SiO₂.

9. The method of claim 1, wherein the substrate is treated with a material that binds the biomaterial on a surface of the substrate.

10. The method of claim 1, wherein the biomaterial is one selected from one of DNA, RNA, LNA, PNA, peptide, a virus, or a cell.

11. The method of claim 2, wherein the monomer is one selected from one of nucleotide, a nucleoside, or an amino acid.

12. A method of preparing a microarray, the method comprising:
introducing a biomaterial into a chamber via a fluid inlet of an adhered structure to immobilize the biomaterial on a surface of a substrate in the chamber, wherein immobilizing the biomaterial comprises exposing the substrate to light via a top portion of the chamber of the adhered structure to expose an active group on the surface of the substrate screened by a photoremovable protecting group; and contacting the exposed active group with an activated monomer protected with the photoremovable protecting group to couple the active group on the surface of the substrate with the monomer.

13. The method of claim 12, further comprising preparing an array mold comprising a concave portion comprising a fluidic channel having said fluid inlet and a fluid outlet, wherein the array mold comprises an optically transparent material; and
adhering a substrate to a surface of the array mold in which the concave portion is formed to form said adhered structure comprising the array mold and the substrate, the adhered structure comprising said chamber defined by a space between the concave portion and the substrate.

14. A method of preparing a microarray, the method comprising:
preparing an array mold comprising at least two substantially identical concave portions comprising a fluidic channel having a fluid inlet and a fluid outlet;
adhering a substrate to a surface of the array mold in which the concave portion is formed to form an adhered structure comprising the array mold and the substrate, the adhered structure comprising a chamber defined by a space between the concave portion and the substrate; and
introducing a biomaterial into the chamber via the fluid inlet of the adhered structure to immobilize the biomaterial on a surface of the substrate in the chamber.

15. The method of claim 14, wherein a top portion of the array mold comprises an optically transparent material.

16. The method of claim 15, wherein immobilizing the biomaterial comprises: exposing the substrate to light via said top portion of the chamber of the adhered structure to expose an active group on the surface of the substrate screened by a photoremovable protecting group; and contacting the exposed active group with an activated monomer protected with the photoremovable protecting group to couple the active group on the surface of the substrate with the monomer.
